(19) United States
(12) Patent Application Publication
(10) Pub. No.: US 2006/0077844 A1
(43) Pub. Date: Apr. 13, 2006

(54) Voice recording and playing equipment

(76) Inventor: Koji Suzuki, Miyazaki-gun (JP)

Correspondence Address: RABIN & Berdo, PC, 1101 14TH STREET, NW, SUITE 500, WASHINGTON, DC, 20005, US

(21) Appl. No.: 11/226,214

(22) Filed: Sep. 15, 2005

(30) Foreign Application Priority Data
Sep. 16, 2004 (JP) 269227/2004

(51) Int. Cl. G11B 7/00

(52) U.S. Cl. 369/53.12

(57) ABSTRACT

The present invention is aimed at changing a playing speed with small operation times without changing the voice pitch.

The solution is as below. A block composition unit 1 receives a voice signal and breaks said voice signal to a blocks having a predetermined length. A ADPCM transformation unit 3 conducts the ADPCM transformation by every blocks thereof. A block characteristics detection unit 4 acquires a block characteristics data having the number of the minimum level sample and the ADPCM data in every blocks thereof. A memory unit 6 stores the ADPCM data transformed by the ADPCM transformation unit 3 and the block characteristics data acquired by the block characteristics data detection unit 4. A data reading unit 7 plays the ADPCM data stored by the memory unit 6. A playing data generation unit 10 watches the data reading unit 7 when an request for repeating block-playing is received, and the playing data generation unit 10 brings the reading point of the ADPCM data to the point of the minimum level sample of the block at a given block number before the current block when the number of the reading sample reaches to the number of the minimum level sample of the current block.

### FIELD OF THE INVENTION

The present invention relates to a voice recording and playing equipment, especially, a voice recording and playing equipment which can change the playing speed (pitch) without changing the pitch, and the method thereof.

In a conventional voice recording and playing equipment, in order to change the playing speed without changing the pitch, a signal having a similar envelope of waveform repeated in the short period (refer to as the unit correlation signal, hereinafter) is inserted thereto to decrease the playing speed, or is deleted to increase the playing speed, using the voice signal characteristics having the autocorrelation during the short time. However, detecting the unit correlation signal needs a very large operating times, and then the conventional technology concentrates on reducing the operating times. (for example, refer to the patent document 1)

As a conventional method to reduce the operation times, the averaging differential magnitude function method (ADMF method) is usually used. In the ADMF method, a voice signal is cut to a predetermined length to get a segment. The segment length is set to N times as long as the sampling period, and the sampling number of the segment ranges from 1 to N. The function of D(m) is defined as the following formula to calculate the repeating period (pitch period) of the unit correlation signal.

$$D ( m ) = ( 1 / N ) {\sum }_{n = 1}^{N} \vert X ( m + n ) - X ( n ) \vert$$

In he above formula, m is changed to detect the minimum value of the D(m), where the value of m is the pitch period. The unit correlation signal can be detected from among the segments thereof, using the pitch period window.

Even if the ADMF method is used, for example, in the case where m starts with 100 and ends at 500 (=N), the operation times to detect the pitch period one time will become not less than about four hundred thousand times, including subtraction, addition, division, and detection of the minimum value. Consequently, a real time playing processing cannot be realized unless a high speed CPU (central processing unit) is used.

For the above mentioned reason, the technology to detect the unit correlation signal has been disclosed. In the technology thereof, a zero-cross point in the voice signal is detected and the short-period autocorrelation of the zero-cross point is used without using the ADMF method in order to detect the unit correlation signal. However, even if the above technology is used, a complicated algorism and a large operation times is necessary to detect the unit correlation signal. In other words, so long as the pitch priod is detected among the segments cut from the voice signal to the predetermined length, the operation times will become very large when the ADMF method is used, while the algorism will become more complicated compared with the ADMF method when the zero-cross-point detecting method is used, even if the reduction of the operation times thereof can be realized to some extent.
Patent document 1: Japanese patent application No. 6-230800.
Patent document 2: Japanese patent application No. 5-19792.

### SUMMARY OF THE INVENTION

The problem to be solved is as below. As long as the pitch period is detected from among the segment being cut from the voice signal to the predetermined length, the operation times will become large when the ADMF method is used, while the algorism will become complicated compared with the ADMF method when the zero-cross-point detecting method is used, even if the reduction of the operation times thereof can be realized to some extent. Consequently, it is impossible that the playing speed is changed without changing the pitch, using a low speed (low cost) CPU. Then, the object of the present invention is the realization of the recording and plying equipment having the capability of recording and playing voice signal without detecting the pitch.

According to the present invention, in the recording side, the block composition unit break the received voice signal segment into blocks having the predetermined length (set have a multiplied number of the sampling period). The length of the block thereof is determined to include at least one unit correlation signal. The block length can be set easily because the frequency limit exists in the low voice frequency area Then, A/D (analog/digital) conversion unit converts the analog sampling level to the digital level, in the receiving order of the block. Secondly, the ADPCM (adaptive pulse code modulation) transformation unit conducts the digital transformation. When the data-storage control unit receives the ADPCM data, the data-storage control unit controls the address and stores the data thereof in the given memory unit. Further, the block characteristics detection unit detects the minimum-level sample having the minimum value of the sampling level in every block and acquire the sample number thereof and the intermediate ADPCM data thereof. Then the block characteristics detection unit stores the sample number thereof and the intermediate ADPCM data thereof in the above memory unit as the block characteristics being corresponding to the above ADPCM value, through the data-storage control unit.

In the playing side, the data reading unit read the ADPCM data from the above memory unit in the order of the address where the data is stored during the above recording and send the data thereof to the ADPCM inverse transformation unit. In the ADPCM inverse transformation unit, the ADPCM data is inversely transformed and is sent to the D/A conversion unit. The D/A conversion unit conducts the D/A conversion of the data thereof and outputs the voice signal for playing. When the order to repeat the voice signal is placed at the beginning of the block, the playing data generation unit reads and holds the sample number of the sample having the minimum level within the block thereof, through the data reading unit. When the reading of the ADPCM data in the data reading unit reaches to the above sample number, the playing data generation unit brings the address of the sample which the data reading unit reads back to the address where the minimum-level sample is stored in the block at one-block before. The reading data unit reads the ADPCM data in the serial order from the address thereof and sends the data to the ADPCM inverse transformation unit. The ADPCM inverse transformation unit inversely transforms the ADPCM data and sends the data to the D/A conversion unit. The D/A conversion unit conducts the D/A conversion and outputs the voice signal for playing. In other words, the present invention has the most remarkable features that the recording and playing of the voice signal can be done without acquiring the pitch period.

The present invention includes the playing data generation unit in addition to the data reading unit. When the order to repeat the block playing is received, the reading unit watches the reading of the ADPCM data. And the playing data generation unit brings the reading address of the APCM data back to the address of the minimum-level sample of the block at one-block before the current reading block, when the sample number of the reading sample reaches to the sample number of the minimum-level sample of the current reading block. According to the aforementioned the playing data generation unit, acquiring the pitch period becomes unnecessary, and then the algorism is simplified. Consequently, the operation times will be reduced very much and the playing speed can be changed without changing the pitch period even if the low CPU is used. The effect can be achieved as described before.

### BRIEF DESCRIPTIO OF THE DRAWING

FIG. 1: A view of functional block diagram of a recording and playing equipment in accordance with the first embodiment.

FIG. 2: A view of operation flow chart of a recording side in accordance with the first embodiment.

FIG. 3: A view of explanation diagram of an operation principal in accordance with the first embodiment.

FIG. 4: A view of operation flow chart of a playing side in accordance with the first embodiment.

FIG. 5: A view of functional block diagram of a recording and playing equipment in accordance with the second embodiment.

FIG. 6: A view of explanation diagram of an operation principal in accordance with the second embodiment.

FIG. 7: A view of explanation diagram of an operation principal in accordance with the second embodiment.

### DETAILED DESCRIPTION OF THE PREFERRED EMBODIMENTS

The present invention is realized by the control measures formed by running the given program of the built-in control unit (CPU), giving the directions to the block forming unit, the ADPCM transformation unit, the block characteristics detection unit, the data storage control unit, the data reading unit, the data playing unit, and the ADPCM inverse transformation unit.

### First Embodiment

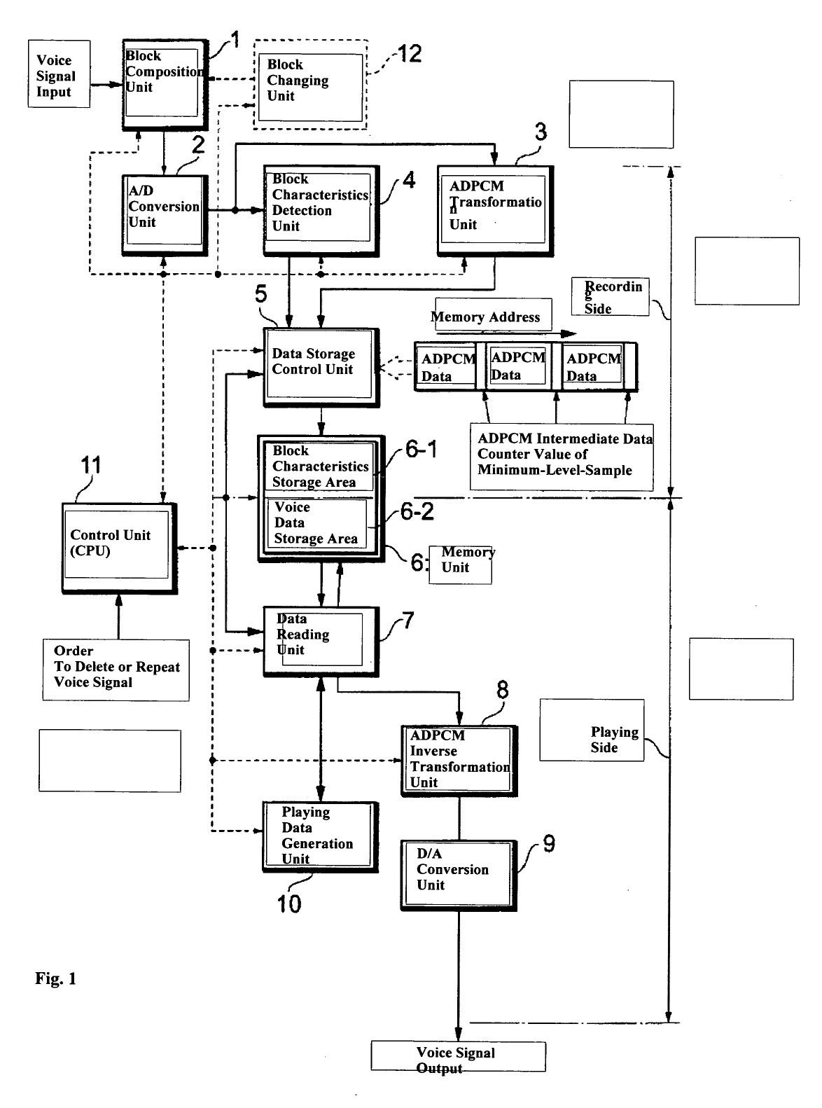

A recording and playing equipment according to the first embodiment is aimed at reducing the playing speed. FIG. 1 is a view of a function bloc diagram of the recording and playing equipment according to the first embodiment. The recording and playing equipment according to the first embodiment includes a block composition unit 1, an A/D conversion unit 2, an ADPCM transformation unit 3, a block characteristics detection unit 4, a data storage control unit 5, a memory unit 6, a data reading unit 7, an ADPCM inverse transformation unit 8, a D/A conversion unit 8, a playing data generation unit 10, and a control unit 11.

The block composition unit 1 break the voice signal segment into blocks having the predetermined length (set to a multiplied number of the sampling period). The length of the block thereof is set to include at least one unit correlation signal. Usually, the length is set, based on the voice low frequency limit of around 100 Hz. At the same time, the bloc length can be changed by a block length changing unit 12, corresponding to the demand.

The A/D conversion unit 2 is an A/D converter. The A/D converter receives the block from the block composition 1 and conducts the A/D conversion of the sample level in the order of the sample number from the head of the block to the tail thereof to send the converted data to the block characteristics detection unit 4 and the ADPCM transformation unit 3. The ADPCM transformation unit 3 receives the data from the A/D conversion unit 2 and conducts the ADPCM (adaptive pulse code modulation) transformation of the data thereof, then send the ADPCM data to the data storage control unit 5.

The block characteristics detection unit 4 receives the output from the A/D conversion init 2, and acquires the sample number of the sample having the minimum value in every block; and acquires the ADPCM intermediate data at the location indicated by the acquired sample number, where the ADPCM intermediate data are the PCM data and the ADPCM data of the previous sample, where the ADPCM data is the differential PCM data between the adjacent samples.

The data storage control unit 5 relates the received ADPCM data from the ADPCM transformation 3 to the received block characteristics from the block characteristics detecting 4, and stores the both data thereof in the memory unit 6 in every block and in the serial order of the sample number, then controls the address thereof.

The memory unit 6 is a RAM (memory) storing the ADPCM data and the block characteristics. The RAM includes the block characteristics storage area 6-1 and the voice data storage area 6-2. The RAM thereof does not need to be installed exclusively for the above use. The part of the RAM being used by the control unit during carrying out the given program can be used for the above purpose.

The data reading unit 7 reads the ADPCM data from the memory unit 6 in the serial order of the address where the data thereof is stored during the above mentioned recording, based on the address control of the data storage control unit 5, so long as a request for additional blocks are not placed thereto.

The ADPCM inverse transform unit 8 inputs the ADPCM data from the data reading unit 7 and outputs the data to the D/A conversion unit after conducting the inverse transform of the data thereof.

The D/A conversion unit 9 receives the output from the ADPCM inverse conversion unit 8 and output the voice signal thereof for the playing.

The playing data generation unit 10 acquires the block characteristics from the memory unit 6 through the data reading unit 7, and reads and holds the number of the sample having the minimum level of the block thereof. Further, when the request for additional blocks is placed thereto, the playing data generation unit 10 watches the sample number of the ADPCM data being read by the data reading unit 7. Then, the playing data generation unit 10 brings the reading sample address by the data reading unit 7 back to the address where the sample having the minimum level is stored in the block located at one-block before the current reading block, when the sample number reaches to the number of the sample having the minimum level.

The control unit 11 is a CPU controlling the whole equipment, and configures the block composition unit 1, the ADPCM transformation unit 3, the block characteristics detection unit 4, the data storage control unit 5, the data reading unit 7, the ADPCM inverse transform unit 8 and the playing data generation unit 10, by carrying out the program stored in a ROM not shown in the drawings.

The operation of the first embodiment will be described as below.

First, the operation of the recording side will be explained, then the operation of the playing said will be explained.

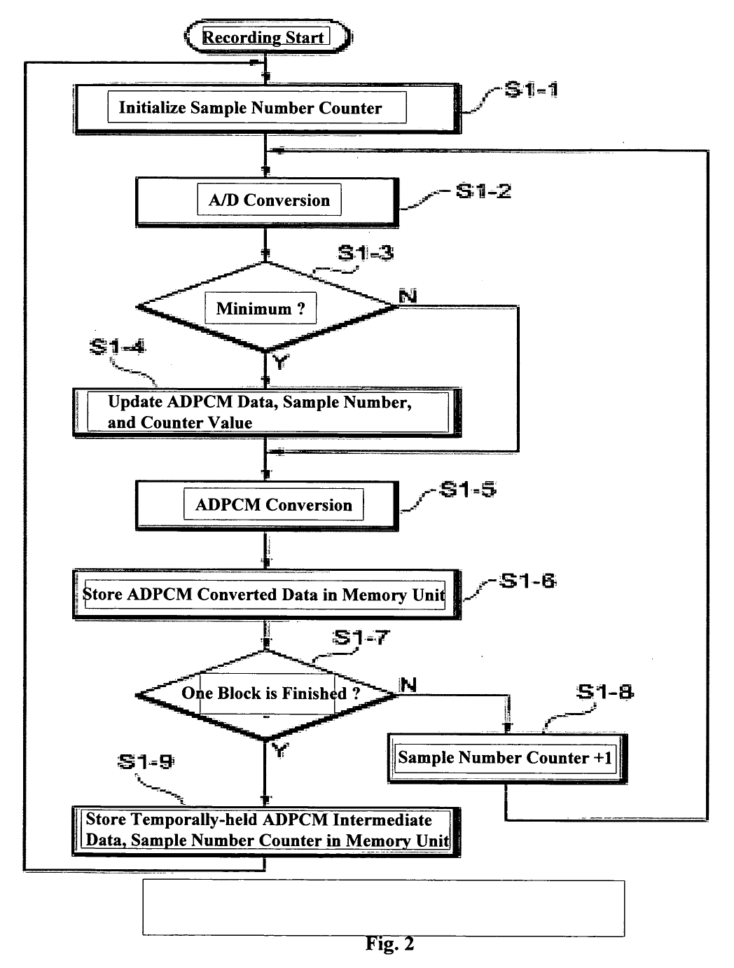

FIG. 2 is a view of the operation flowchart (the recording side) in accordance with the first embodiment.

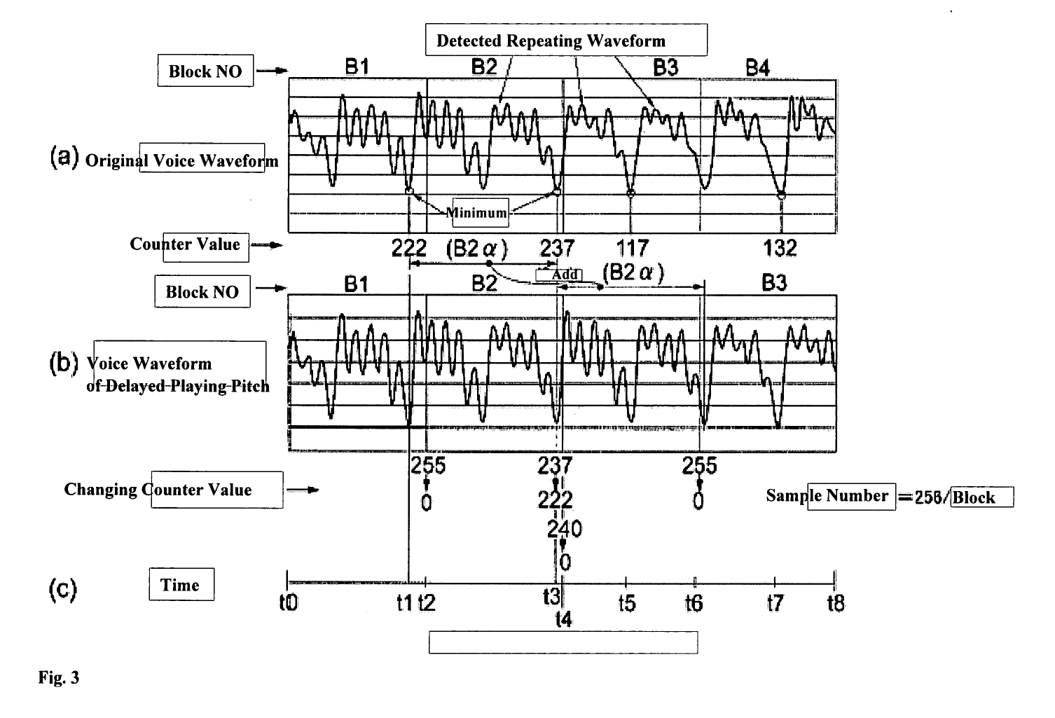

FIG. 3 is a explanatory view of the principal of an operation in accordance with the first embodiment, and is referred to as the explanation of FIG. 2. The line of (a) in FIG. 3 is the original voice waveform (the recording side). The line of (b) in FIG. 3 is the voice waveform (the playing side) having the lowered playing pitch. The line of (c) in FIG. 3 shows the common time scale for both the line of (a) and (b).

The voice recording and playing equipment according to the first embodiment will be explained, using steps from the step S1-1 to the step S1-9 in FIG. 2 in the serial order of the step thereof.

The Precondition of the Explanation of the Operation:

The sampling frequency is 32 KHz. The number of a block is 256 (from NO-0 to NO-255).

The one-block sample number of the voice signal is set to 256 by the block composition unit 1 (FIG. 1), and the voice signal thereof inputs to the A/D conversion 2 (FIG. 1), then the operation of the recording starts.

The Step S1-1:

The control unit 11 (FIG. 1) initializes the sample number counter included in the CPU.

The Step S1-2:

The A/D conversion 2 (FIG. 1) conducts the A/D conversion of the sample level of the received voice signal thereto.

The Step S1-3:

The block characteristics detection unit 4 (FIG. 1) compares the level of the current received sample with the self-held level therein of the sample having the minimum level before receiving the current received sample thereof. In the case when the level of the received sample is lower than the level of the sample having the minimum level, the step S1-3 proceeds to the step S1-4, while in the case when the level of the received sample is equal to or higher than the level of the sample having the minimum level, the operation thereof proceeds to the step S1-5. However, when the received sample is the first sample, the step S1-3 proceeds to the step S1-4.

The Step S1-4:

The block characteristics detection unit 4 (FIG. 1) updates the number, the level, and the intermediate ADPCM data of the sample thereof, and updates the self-held number, the self-held level, and the self-held intermediate ADPCM data of the sample having the minimum level before the current time.

The Step S1-5:

The ADPCM transformation unit 3 (FIG. 1) transforms the received data level to the ADPCM data.

The Step S1-6:

The data storage control unit 5 (FIG. 1) receives the ADPCM data from the ADPCM transformation unit 3 (FIG. 1) and stores the data thereof at the predetermined address of the memory unit 6 (FIG. 1).

The Step S1-7:

In the case where the processing of the all sample within the block is finished, the step S1-7 proceeds to the step S1-8, while in the case where the processing thereof is not finished, the step S1-7 proceeds to the step S1-9.

The Step S1-8:

The control unit 11 (FIG. 1) increments the sample number counter included in the CPU and bring the operation thereof back to the step S1-2. Then the following sample is processed in the same way as the aforementioned one.

The Step S1-9:

The data storage control unit 5 (FIG. 1) receives the sample number, the level, and the intermediate ADPCM data being held at the moment from the block characteristics unit 4 (FIG. 1) and stores the number, level, and the data thereof as the block data in the memory unit 6 (FIG. 1). Then the data storage control unit 5 goes back to the step S1-1 and processes the following block.

In the aforementioned flow chart, for example, as shown in the line of (a) in FIG. 3, the sample NO-222 of the block B1, the sample NO-237 of the block B2, the sample NO-118 of the block B3, or the sample NO-132 of the block B4 is detected to be the minimum level, respectively. It must be considered that the number of the detected minimum-level sample is only one, even if a plurality of unit correlation signal are included in one block.

The description of the playing-side operation will be as below.

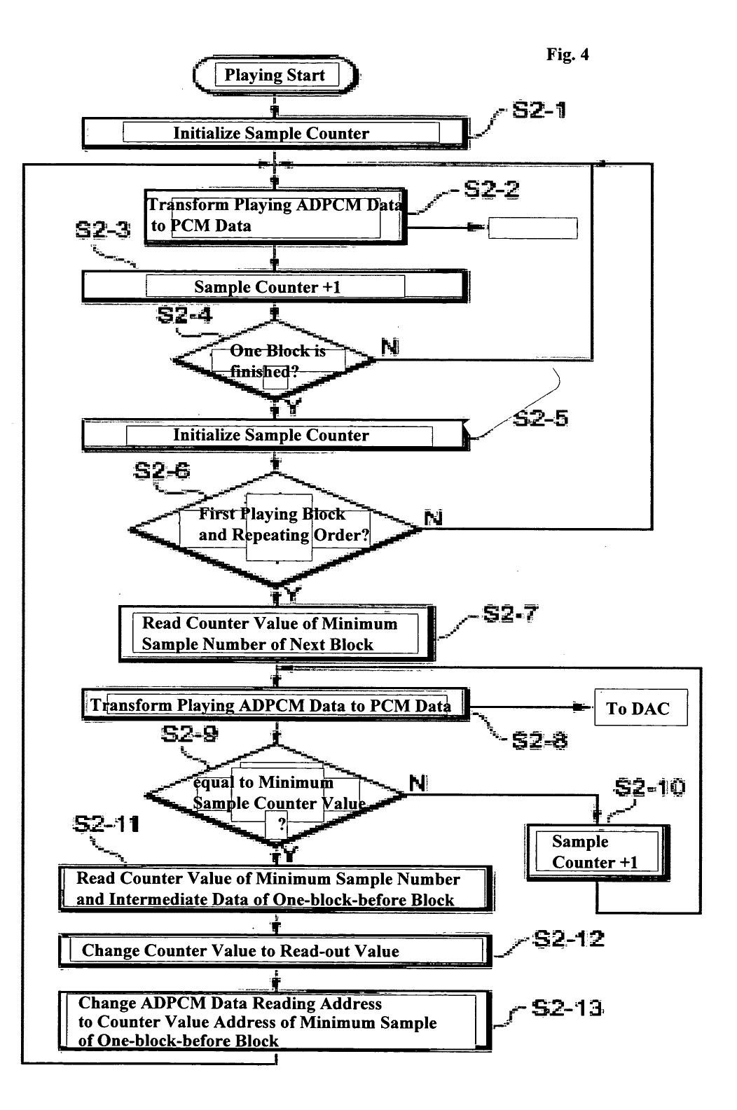

FIG. 4 is a view of the operation flow chart (the playing side). The precondition of the description of the operation:

In the voice-signal input to the recording side shown in the line of (a) in FIG. 3, the waveform (B2a) having the time-length from the time t1 to the time t4 is supposed to be inserted at the playing side. The description of the operation thereof will be done on the above assumption.

The playing side operation of the voice recording and playing equipment according to the first embodiment will be explained in the serial order of the processing step from the step S2-1 to the step S2-13 in the FIG. 4.

For example, after the block characteristics and the ADPCM characteristics are stored in the memory unit 5 (FIG. 1), the playing thereof starts.

The Step S2-2:

The control unit 11 (FIG. 1) initializes the sample number counter built in the CPU.

The Step S2-2:

The data reading unit 7 (FIG. 1) reads the ADPCMN data from the memory unit 6 (FIG. 1). The ADPCM inverse transformation unit 8 (FIG. 1) transforms the ADPCM data thereof to the PCM data. The PCM data thereof outputs as the playing voice signal through the D/A conversion unit 9 (FIG. 1). In the case hereof, the block B1 (the line (b) of FIG. 3) is played.

The Step S2-3:

The control init 11 (FIG. 1) increments the sample number counter built in the CPU.

The Step S2-4:

The process from The step S2-2 to the step S2-4 is repeated till the processing of one block (where one block is the block B1 (the line (b) of FIG. 3)) is finished. The step S2-4 proceeds to the step S2-5 after one block after the processing of the one block is finished.

The Step S2-5:

The control unit 11 (FIG. 1) initializes the sample counter built in the CPU. As the processing of the block B1 in finished at the time t2, as shown in the line (b) of FIG. 3, the counter value changes from 255 to 0.

The Step S2-6:

The following block is the first playing block, and the step S2-6 proceeds to S2-7 when the request for addition is placed. In the case where the playing thereof is not the first one or a request for addition (repeating order) is not placed, the step S2-6 goes back to the step S2-2 and then the processing from the step S2-1 to the step S2-6 is repeated. In the case of the block B2 (the line (b) of FIG. 3), as the paying thereof is the first playing after the playing of block B1 (the line (b) of FIG. 3) and the request for addition (repeating order) is placed, the step S2-6 proceeds to the step S2-7.

The Step S2-7:

The playing data generation unit 10 (Fib. 1) acquires the data block characteristics from the memory unit 6 (FIG. 1) through the data reading unit 7 (FIG. 1), and starts watching the sample number of the ADPCM data read by the data reading unit 7 (FIG. 1), reading and holding the sample number of the minimum sample of the current block.

The Step S2-8:

The ADPCM inverse transformation unit 8 (FIG. 1) transforms the ADPCM data to the PCM data. The ADPCM data is read from the memory unit 7 (FIG. 1) by the data reading unit 7 (FIG. 1). The PCM data thereof outputs as the playing voice signal through the D/A conversion unit 9 (FIG. 9). In the case hereof, a part of the block B2 (the line (b) of FIG. 3) is played.

The Step S2-9:

Before the playing data generation unit 10 (FIG. 1) detects a matching between the sample number of the ADPCM data being read by the data reading unit 7 (FIG. 1) and the sample number of the sample having the minimum sample level, the step S2-9 proceeds to the step S2-10, while after the playing data generation unit 9 detects the matching thereof, the step s2-9 proceeds to the step S2-11.

The Step S2-10:

After the control unit 11 (FIG. 1) increments the sample number counter built in the CPU, the control unit 11 repeats the processing from the step S2-8 to the step S2-9 to the step S2-10. In the case hereof, till the sample NO-237 of the block B2 is reached to, the step S2-8, the step S2-9, and the step S2-10 are repeated.

The Step S2-11:

The playing data generation unit 10 (FIG. 1) acquires the block characteristics of the block located at one-block before the current block. In the case hereof, the intermediate ADPCM data of the sample NO-222 having the minimum sample level of the block B1 as shown in the line (b) of FIG. 3 and the intermediate ADPCM data of the current sample thereof are read from the memory unit 6 (FIG. 1) through the data reading unit 7 (FIG. 1).

The Step S2-12:

The playing data generation unit 10 (FIG. 1) changes the value of the sample counter built in the CPU to the sample number of the sample having the minimum level of the block located at the one-block before the current block thereof, where the sample number thereof is read in the step S2-11. In the case hereof, the current counter value of 237 is changed to the counter value of 222 of the minimum level sample in the block B1.

The Step S2-13:

The data reading unit 7 (FIG. 1) reads the ADPCM data from the address of the memory unit 6 (FIG. 1) where the sample NO-222 of the minimum level sample in the block B1 is stored, and the processing thereof goes back to the step S2-2. The following step flows go through the same way as the abovementioned way, and when the predetermined playing is finished, the step flow thereof is completed. In the case hereof, the operation continues as below.

The processing of the counter value of 222 thereof (the time t3) goes back to the step S2-2, and the ADPCM data is read in the serial order of the address from the address of the memory unit 6 (FIG. 1) where the sample NO-222 of the block B1 (the line (a) of FIG. 3) is stored. The sequence from step S2-2 though the step S2-3 to the step S2-4 back to the step S2-2 is repeated. After one block of the playing side is finished at the time t4, the operation goes through to the step S2-5, playing the block B2a (the line (a) of FIG. 3).

At the moment, the counter value of 240 is initialized to 0 (the step S2-5), and after the moment the original voice waveforms are read serially, based on the initialized counter value thereof. As the result, the ‘B2a’ part of the original voice waveforms (the line (a) of FIG. 3) is added to the waveform (b) having the lowered playing pitch.

As explained before, according to the first embodiment, the operation is as below. When the block repeating request is received, the data generation unit 10 (FIG. 1) starts watching the reading of the ADPCM data by the data reading unit 7 (FIG. 1). When the reading sample number reaches to the number of the sample having the minimum level of the current reading block, the reading address of the ADPCM data by the data reading unit 7 (FIG. 1) only needs to be backed to the address where the minimum level sample of the one-block before the current reading block is stored. At the same time the pitch period thereof is not ought to be acquired. Consequently, the algorism is simplified and the operation times is reduced to large extent. As the result, the effect that the playing speed can be decreased without changing the pitch even if the low speed (cost) CPU is used; is achieved.

In the above explanation, the minimum level is acquired as the block characteristics. The present invention is not limited to the case thereof. In other words, detecting the sample having the maximum level in every block and replacing the minimum level sample is replaced with the maximum level sample thereof; can bring the same effect as in the above explanation.

As explained before, when the block repeating request is received, the data generation unit 10 (FIG. 1) starts watching the reading of the ADPCM data by the data reading unit 7 (FIG. 1). When the reading sample number reaches to the number of the sample having the minimum level of the current reading block, the reading address of the ADPCM data by the data reading unit 7 (FIG. 1) is backed to the address where the minimum level sample at the one-block before the current reading block is stored. The present invention does not limit to the case thereof. In other words, the reading address of the ADPCM data by the data reading unit 7 (FIG. 1) can be backed to the address where the minimum level sample of the block located at the several blocks before the current reading block thereof.

Further, the above explanation is limited to the operation in the case when the additional block request is received only one time. However, the present invention does not limit to the case thereof. In other words, when the additional block requests are received in a plurality of times, decreasing the playing speed in the given times can be done by a plurality of the aforementioned operation.

### Second Embodiment

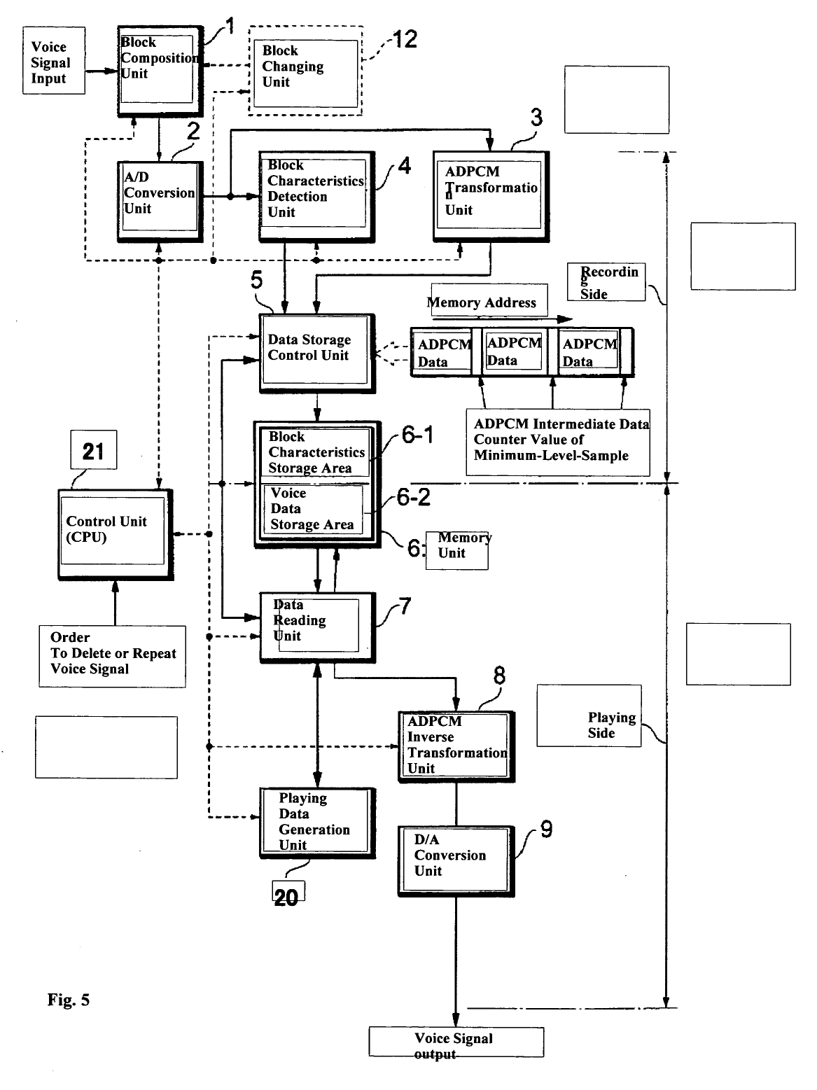

A voice signal recording and playing equipment according to the second embodiment is aimed at increasing the playing speed. FIG. 5 is view of functional block diagram of a voice signal recording and playing equipment according to the second embodiment. As shown in the drawing, the voice signal recording and playing equipment according to the present invention includes the block composition unit 1, the A/D conversion unit 2, the ADPCM transformation unit 3, the block characteristics detection unit 3, the data storage control unit 5, the memory unit 6, the data reading unit 7, the ADPCM inverse transformation unit 8, the D/A conversion unit 9, and a playing data generation unit 20, and a control unit 21.

The parts different from the first embodiment will be only explained hereinafter. And the explanation of the parts that are identical to the parts of the first embodiment will be omitted for the sake of brevity, being given the same reference numerals as the parts of the first embodiment.

The playing data generation unit 20 reads and holds the number of the minimum level sample of the current block, acquiring the block characteristics thereof from the memory unit 6 through the data reading unit 7. Further, when the block delete request comes thereto, the playing data generation unit 20 starts watching the number of the reading sample of the ADPCM data read by the data reading unit 7. Further, when the sample number thereof reaches the number of the minimum level sample, the playing data generation unit 20 brings the reading address used in the data reading unit 7 back to the address of the minimum-level sample of the block at one-block after the current reading block. In addition, the block delete request is sent to the playing data generation unit 20 from the control unit, based on the setting by the operator.

The control unit 21 controls the whole equipment. By carrying out the preinstalled program of a ROM (memory) not shown in the drawings, the control unit 21 configures the block composition unit 1, the ADPCM transformation unit, the block characteristics detection unit 4, the data storage control unit 5, the data reading unit 7, the ADPCM inverse transformation unit 8, and the playing data generation unit 20.

The operation according to the second embodiment will be explained as below. The operation of the recording side is same as the first embodiment, the explanation thereof will be omitted, and only the operation pf the playing side will be explained hereinafter.

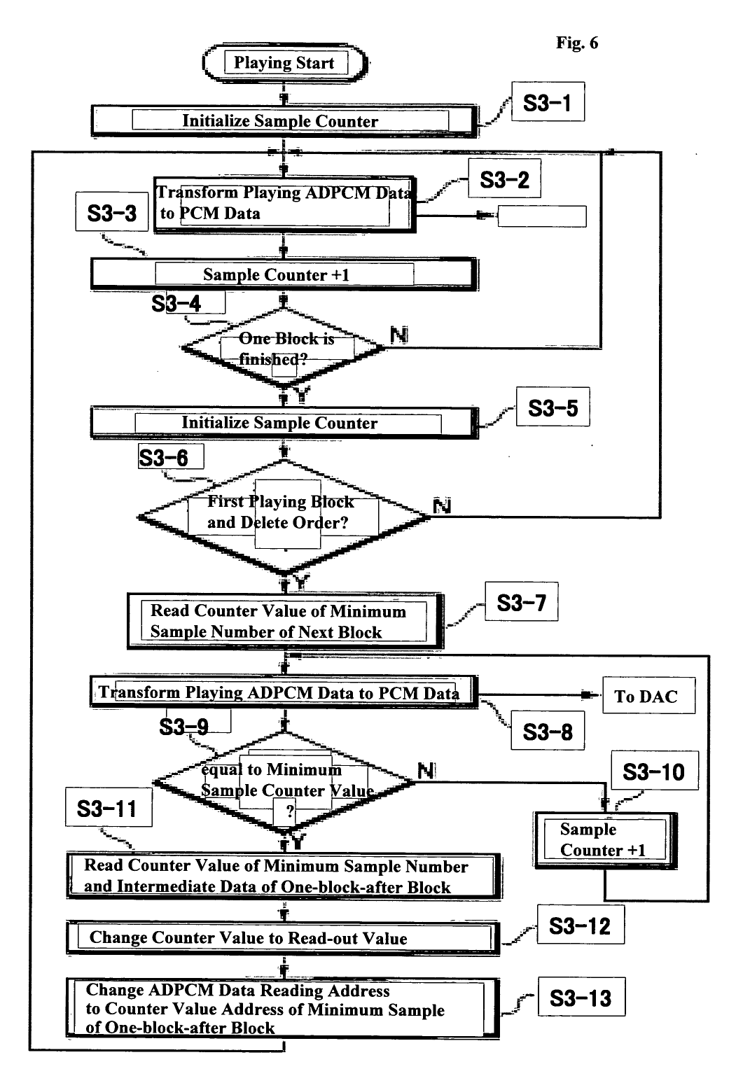

FIG. 6 is a view of the operation flow of the recording side in accordance with the second embodiment.

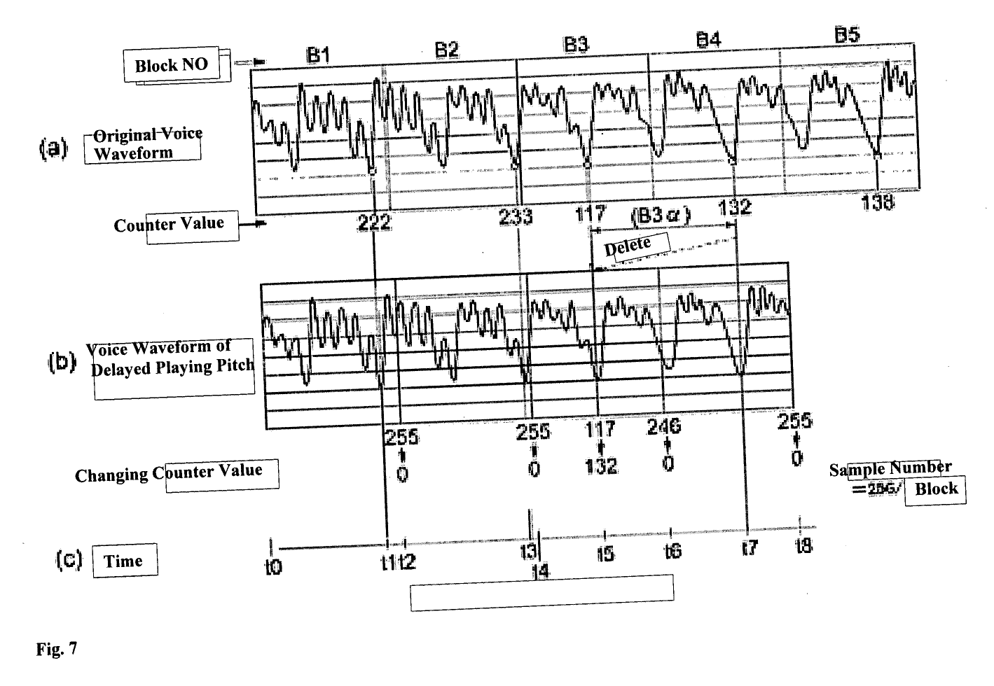

FIG. 7 is a explanation view of the operation principle in accordance with the second embodiment. The drawing is referred to in the explanation of FIG. 6. The line (a) is the original voice waveform (recording side). The line (b) is the voice waveform (playing side) having quickened playing pitch thereof. The line (c) is the common time scale.

The Precondition for the Explanation of the Operation:

It will be assumed that the waveform during the period from the time t5 to the time t7 is deleted in the playing side. The explanation hereinafter will be based on the assumed operation thereof.

The operation of the playing side according to the second embodiment will be explained in the serial order of the steps from the step S3-1 to the step S3-13 of FIG. 6. For example, the playing starts after the block characteristics and the ADPCM data both are stored in the memory unit 6 (FIG. 5), where the block characteristics and the ADPCM data are shown in the line (a) of FIG. 7.

The Step S3-1:

A control unit 21 (FIG. 5) initializes the sample number counter built in the CPU.

The Step S3-2:

The ADPCM inverse transformation unit 8 (FIG. 5) transforms the ADPCM data to the PCM data. The ADPCM data thereof is read from the memory unit 6 (FIG. 5) by the data reading unit (FIG. 5). The PCM data thereof outputs as the playing voice signal through the D/A conversion unit 9 (FIG. 5). In the case hereof, the block B1 (the line (b) of FIG. 3) is played.

The Step S3-3:

The control unit 21 (FIG. 5) increments the sample number counter built in the CPU.

The Step S3-4:

Before the one-block (the block B1 (the line (a) of FIG. 7) in the case hereof) processing is finished, the processing from the step S3-2 to the step S3-4 is repeated. When the one-block processing is finished, the step S3-4 proceeds to the step S3-5.

The Step S3-5:

The control unit 21 (FIG. 5) initializes the sample number counter built in the CPU. As shown in the line (b) of FIG. 7, as the processing of the block B1 is finished at the time t2, the counter value thereof changes to 0 from 255.

The Step S3-6:

In the case where the following block is the first one to be played and the block delete request (delete order) is placed thereto, the step S3-6 proceeds to the step S3-7. While, in the case where the following block is not first one to be played, or the block delete request (delete order) is not placed thereto, the step S3-6 goes back to the step S3-2 and the processing from the step S3-1 to the step S3-6 is repeated. In the case hereof, the block B2 (the line (b) of FIG. 7) is the first block to be played after the block B1, however the delete

The Step S3-8:

The ADPCM inverse transformation 8 (FIG. 5) transforms the ADPCM data to the PCM data. The ADPCM data thereof is read from the memory unit 6 (FIG. 5) by the data reading block unit 7 (FIG. 5). The PCM data outputs as the playing voice signal through the D/A conversion unit 9 (FIG. 5). In the case hereof, a part of the block B3 (The line (b) of the FIG. 7) is played

The Step S3-9:

Before the playing data generation unit 20 (FIG. 5) detects a matching between the sample number of the ADPCM data being read by the data reading unit 7 (FIG. 5) and the sample number of the sample having the minimum sample level, the step S3-9 proceeds to the step S3-10, while after the playing data generation unit 9 detects the matching thereof, the step S3-9 proceeds to the step S3-11.

The Step S3-10:

After the control unit 21 (FIG. 5) increments the sample number counter built in the CPU, the control unit 21 repeats the processing from the step S3-8 to the step S3-9 to the step S3-10. In the case hereof, till the sample NO-117 of the block B3 is reached to, the step S3-8, the step S3-9, and the step S3-10 are repeated.

The Step S3-11:

The playing data generation unit 20 (FIG. 5) acquires the block characteristics of the block located at one-block after the current block. In the case hereof, the intermediate ADPCM data of the sample NO-117 having the minimum sample level of the block B4 as shown in the line (a) of FIG. 7 and the intermediate ADPCM data of the current sample thereof are read from the memory unit 6 (FIG. 5) through the data reading unit 7 (FIG. 5).

The Step S2-12:

The playing data generation unit 20 (FIG. 5) changes the value of the sample counter built in the CPU to the sample number of the sample having the minimum level of the block located at the one-block after the current block thereof, where the sample number thereof is read in the step S3-11. In the case hereof, the current counter value of 117 is changed to the counter value of 132 of the minimum level sample in the block B4.

The Step S2-13:

The data reading unit 7 (FIG. 5) reads the ADPCM data from the address of the memory unit 6 (FIG. 5) where the sample NO-132 of the minimum level sample in the block B4 is stored, and the processing thereof goes back to the step S3-2. The following step flows go through the same way as the abovementioned way, and when the predetermined playing is finished, the step flow thereof is completed. In the case hereof, the operation continues as below.

The processing of the counter value of 132 thereof (the time t5) goes back to the step S3-2, and the ADPCM data is read in the serial order of the address from the address of the memory unit 6 (FIG. 5) where the sample NO-132 of the block B4 (the line (a) of FIG. 7) is stored. The sequence from the step S3-2 though the step S3-3 to the step S3-4 back to the step S3-2 is repeated. After one block of the playing side is finished at the time t6, the operation goes through to the step S3-5, playing the block B4 (the line (a) of FIG. 7).

At the moment, the counter value of 246 is initialized to 0 (the step S3-5), and after the moment the original voice waveforms are read serially, based on the initialized counter value thereof. As the result, the ‘B3a’ part of the original voice waveforms (the line (a) of FIG. 7) is deleted.

As explained before, according to the second embodiment, the operation is as below. When the block delete request is received, the data generation unit 20 (FIG. 5) starts watching the reading of the ADPCM data by the data reading unit 7 (FIG. 5). When the reading sample number reaches to the number of the sample having the minimum level of the current reading block, the reading address of the ADPCM data by the data reading unit 7 (FIG. 5) only needs to be proceeded to the address where the minimum level sample of the one-block after the current reading block is stored. At the same time the pitch period thereof is not ought to be acquired. Consequently, the algorism is simplified and the operation times is reduced to large extent. As the result, the effect that the playing speed can be increased without changing the pitch even if the low speed (cost) CPU is used; is achieved.

In the above explanation, the minimum level is acquired as the block characteristics. The present invention is not limited to the case thereof. In other words, detecting the sample having the maximum level in every block and replacing the minimum level sample is replaced with the maximum level sample thereof; can bring the same effect as in the above explanation.

As explained before, when the block repeating request is received, the data generation unit 20 (FIG. 5) starts watching the reading of the ADPCM data by the data reading unit 7 (FIG. 5). When the reading sample number reaches to the number of the sample having the minimum level of the current reading block, the reading address of the ADPCM data by the data reading unit 7 (FIG. 5) is proceeded to the address where the minimum level sample at the one-block after the current reading block is stored. The present invention does not limit to the case thereof. In other words, the reading address of the ADPCM data by the data reading unit 7 (FIG. 5) can be proceeded to the address where the minimum level sample of the block located at the several blocks before the current reading block thereof.

Further, the above explanation is limited to the operation in the case when the additional block request is received only one time. However, the present invention does not limit to the case thereof. In other words, when the additional block requests are received in a plurality of times, decreasing the playing speed in the given times can be done by a plurality of the aforementioned operation.

At the same time, the abovementioned playing data generation unit 20 can include the function of playing data generation unit 10 according to the first embodiment. In the case hereof, the playing speed can be changed freely, for example, the playing pitch can be decreased or increased.

The above explanation of the present invention is limited to the case where the present invention is applied to the ADPCM data. However, the present invention is not limited to the case thereof. In other words, the present invention can be applied to the PCM data.

What is claimed is:

1. A voice recording and playing equipment, comprising;
a block composition unit being configured to receives a voice signal and breaks said voice signal to blocks having a predetermined length;
a digitalization unit being configured to digitalizes a sample level in the serial order of the sample number from the top to the bottom of each block of said blocks;
a block characteristics detection unit being configured to acquires a block characteristics including a number of the sample having the minimum level in each block of said blocks and an intermediate of said sample;
a memory unit being configured to stores the digital data digitalized by said digitalization unit and said block characteristics acquired by said block characteristics detection unit;
a data reading unit being configured to read serially the digitalized data stored by said memory unit and play said digitalized data;
a delayed-playing-data generation unit being configured to watch the reading by said data reading unit, when a request for addition blocks for playing is received thereto, and being configured to bring the reading point of said digitalized data by said data reading unit back to the reading point of the minimum level sample of the block at a given block number before the current reading block of said data reading unit, when the reading sample number reaches to the minimum sample number of said current reading block.

2. The voice signal recording and playing equipment according to claim 1, wherein said delayed-playing-data generation unit is replaced by a quickened-playing-data generation unit being configured to watch the reading by said data reading unit, when a request for delete blocks for playing is received thereto, and being configured to bring the reading point of said digitalized data by said data reading unit forward to the reading point of the minimum level sample of the block at a given block number after the current reading block of said data reading unit, when the reading sample number reaches to the minimum sample number of said current reading block.

3. A voice recording and playing equipment, comprising;
a block composition unit being configured to receives a voice signal and breaks said voice signal to blocks having a predetermined length;
a digitalization unit being configured to digitalizes a sample level in the serial order of the sample number from the top to the bottom of each block of said blocks;
a block characteristics detection unit being configured to acquires a block characteristics including a number of the sample having the maximum level in each block of said blocks and an intermediate of said sample;
a memory unit being configured to stores the digital data digitalized by said digitalization unit and said block characteristics acquired by said block characteristics detection unit;
a data reading unit being configured to read serially the digitalized data stored by said memory unit and play said digitalized data;
a delayed-playing-data generation unit being configured to watch the reading by said data reading unit, when a request for addition blocks for playing is received thereto, and being configured to bring the reading point of said digitalized data by said data reading unit back to the reading point of the maximum level sample of the block at a given block number before the current reading block of said data reading unit, when the reading sample number reaches to the maximum sample number of said current reading block.

4. The voice signal recording and playing equipment according to claim 1, wherein said delayed-playing-data generation unit is replaced by a quickened-playing-data generation unit being configured to watch the reading by said data reading unit, when a request for delete blocks for playing is received thereto, and being configured to bring the reading point of said digitalized data by said data reading unit forward to the reading point of the maximum level sample of the block at a given block number after the current reading block of said data reading unit, when the reading sample number reaches to the maximum sample number of said current reading block.

5. The voice signal recording and playing equipment according to claim 1, includes a data storage control unit being configured to store said digitalized data by said digitalization unit and said block characteristics data acquired by said block characteristics detection unit in said memory unit, with both data corresponded to each other.

6. A voice recording and playing method, comprising;
a step being configured to receive a voice signal and break said voice signal to blocks having a predetermined length;
a step being configured to digitalize a sample level in the serial order of the sample number from the top to the bottom of each block of said blocks;
a step being configured to acquire a block characteristics data including a number of the sample having the minimum level in each block of said blocks and an intermediate data of said sample;
a step being configured to store the digitalized data and said block characteristics data with both data corresponded to each other;
a step being configured to read serially said digitalized data from said memory and play said digitalized data;
a delayed-playing-data generation step being configured to watch the reading, when a request for addition blocks for playing is received thereto, and being configured to bring the reading point of said digitalized data back to the reading point of the minimum level sample of the block at a given block number before the current reading block, when the playing sample number reaches to the minimum sample number of said current reading block.

7. The voice signal recording and playing method according to claim 6, wherein said delayed-playing-data generation step is replaced by a quickened-playing-data generation step being configured to watch the playing of said digitalized data, when a request for delete blocks for playing is received thereto, and being configured to bring the reading point of said digitalized data forward to the reading point of the minimum level sample of the block at a given block number after the current reading block, when the playing sample number reaches to the minimum sample number of said current reading block.

8. A voice recording and playing method, comprising;
a step being configured to receive a voice signal and break said voice signal to blocks having a predetermined length;
a step being configured to digitalize a sample level in the serial order of the sample number from the top to the bottom of each block of said blocks;
a step being configured to acquire a block characteristics data including a number of the sample having the maximum level in each block of said blocks and an intermediate data of said sample;
a step being configured to store the digitalized data and said block characteristics data with both data corresponded to each other;
a step being configured to read serially said digitalized data from said memory and play said digitalized data;
a delayed-playing-data generation step being configured to watch the reading, when a request for addition blocks for playing is received thereto, and being configured to bring the reading point of said digitalized data back to the reading point of the maximum level sample of the block at a given block number before the current reading block, when the playing sample number reaches to the maximum sample number of said current reading block.

9. The voice signal recording and playing method according to claim 8, wherein said delayed-playing-data generation step is replaced by a quickened-playing-data generation step being configured to watch the playing of said digitalized data, when a request for delete blocks for playing is received thereto, and being configured to bring the reading point of said digitalized data forward to the reading point of the maximum level sample of the block at a given block number after the current reading block, when the playing sample number reaches to the maximum sample number of said current reading block.

10. The voice signal recording and playing equipment according to claim 2, includes a data storage control unit being configured to store said digitalized data by said digitalization unit and said block characteristics data acquired by said block characteristics detection unit in said memory unit, with both data corresponded to each other.

11. The voice signal recording and playing equipment according to claim 3, includes a data storage control unit being configured to store said digitalized data by said digitalization unit and said block characteristics data acquired by said block characteristics detection unit in said memory unit, with both data corresponded to each other.

12. The voice signal recording and playing equipment according to claim 4, includes a data storage control unit being configured to store said digitalized data by said digitalization unit and said block characteristics data acquired by said block characteristics detection unit in said memory unit, with both data corresponded to each other.
